(19) United States
(12) Patent Application Publication
(10) Pub. No.: US 2020/0128029 A1
(43) Pub. Date: Apr. 23, 2020

(54) NETWORK DEVICE, MONITORING AND CONTROL DEVICE, NETWORK SYSTEM, AND CONTROL METHOD THEREFOR

(71) Applicant: NEC CORPORATION, Tokyo (JP)

(72) Inventor: Tomotsune NISHIMURA, Tokyo (JP)

(73) Assignee: NEC CORPORATION, Tokyo (JP)

(21) Appl. No.: 16/493,408

(22) PCT Filed: Feb. 7, 2018
(86) PCT No.: PCT/JP2018/004127

§ 371 Date: Sep. 12, 2019

(30) Foreign Application Priority Data
Mar. 13, 2017 (JP) 2017-047574

(51) Int. Cl. H04L 29/06; H04L 12/707

(52) U.S. Cl. CPC H04L 63/1416; H04L 63/1441; H04L 63/1425; H04L 45/24

(57) ABSTRACT

An NE (10) according to the present invention includes a main signal transfer unit (11) configured to transfer a main signal for user data through a main signal path r1 between this NE (10) and another NE (10), a monitoring and control processing unit (12) configured to transmit and receive a monitoring and control signal for monitoring and control through a monitoring and control path r2 between this NE (10) and an NMS (20), and a path separation unit (13) configured to separate the main signal path r1 and the monitoring and control path r2 upon detection of unauthorized access. This provides a network device capable of diminishing effects on communication services by the main signal.

### TECHNICAL FIELD

The present invention relates to a network device, a monitoring and control device, a network system, and a method of controlling them and, particularly, relates to a network device, a monitoring and control device, and a network system that transfer a main signal, and a method of controlling them.

### BACKGROUND ART

A variety of threats have become a serious concern today with the popularization of network systems, and security countermeasures are essential for network systems. With regard to security countermeasures, various techniques related to unauthorized access such as attacks (cyber attacks) against equipment constituting a network system, for example, have been developed.

Patent Literatures 1 to 5 are known related techniques. For example, Patent Literature 1 discloses an analysis technique for accurately detecting unauthorized access, and Patent Literature 2 discloses a technique for detecting botnet infection. Patent Literature 3 discloses a technique for filtering unauthorized access packets. Patent Literature 4 discloses a network node path update method, and it discloses a monitoring method of monitoring frames flowing through a network.

### CITATION LIST

### Patent Literature

### PTL1: Japanese Unexamined Patent Application Publication No. 2015-121968

### PTL2: Published Japanese Translation of PCT International Publication for Patent Application, No. 2015-502060

### PTL3: Japanese Unexamined Patent Application Publication No. 2006-114991

### PTL4: Japanese Unexamined Patent Application Publication No. 2014-175685

### PTL5: Japanese Unexamined Patent Application Publication No. 2008-252924

### SUMMARY OF INVENTION

### Technical Problem

As described above, the related techniques carry out unauthorized access detection or filtering in network systems. However, although the related techniques can prevent unauthorized access, there is no consideration of effects on communication services by a main signal (user data).

In view of the foregoing, it is an object of the present invention to provide a network device, a monitoring and control device, a network system and a method of controlling them that diminish effects on communication services by a main signal.

### Solution to Problem

A network device according to the present invention includes a main signal transfer means for transferring a main signal for user data through a main signal path between the network device and another network device, a monitoring and control processing means for transmitting and receiving a monitoring and control signal for monitoring and control through a monitoring and control path between the network device and a monitoring and control device, and a path separation means for separating the main signal path and the monitoring and control path upon detection of unauthorized access.

A monitoring and control device according to the present invention is a monitoring and control device for monitoring and controlling a network device constituting a network, the device including a monitoring and control processing means for transmitting and receiving a monitoring and control signal for monitoring and control through a monitoring and control path between the monitoring and control device and the network device, and a path separation means for separating a main signal path for transferring a main signal for user data by the network device and the monitoring and control path upon detection of unauthorized access to the network device.

A network system according to the present invention is a network system including a network device constituting a network and a monitoring and control device for monitoring and controlling the network device, the system including an unauthorized access detection means for detecting unauthorized access to the network device, and a path separation means for separating a main signal path for transferring a main signal for user data by the network device and a monitoring and control path for transmitting and receiving a monitoring and control signal for monitoring and control between the network device and the monitoring and control device upon detection of the unauthorized access.

A method of controlling a network device according to the present invention is a method of controlling a network device constituting a network, the method including transferring a main signal for user data through a main signal path between the network device and another network device, transmitting and receiving a monitoring and control signal for monitoring and control through a monitoring and control path between the network device and a monitoring and control device, and separating the main signal path and the monitoring and control path upon detection of unauthorized access.

A method of controlling a monitoring and control device according to the present invention is a method of controlling a monitoring and control device for monitoring and controlling a network device constituting a network, the method including transmitting and receiving a monitoring and control signal for monitoring and control through a monitoring and control path between the monitoring and control device and the network device, and separating a main signal path for transferring a main signal for user data by the network device and the monitoring and control path upon detection of unauthorized access to the network device.

A method of controlling a network system according to the present invention is a method of controlling a network system including a network device constituting a network and a monitoring and control device for monitoring and controlling the network device, the method including detecting unauthorized access to the network device, and separating a main signal path for transferring a main signal for user data by the network device and a monitoring and control path for transmitting and receiving a monitoring and control signal for monitoring and control between the network device and the monitoring and control device upon detection of the unauthorized access.

### Advantageous Effects of Invention

According to the present invention, it is possible to provide a network device, a monitoring and control device, a network system and a method of controlling them that diminish effects on communication services by a main signal.

### BRIEF DESCRIPTION OF DRAWINGS

FIG. 1 is a configuration diagram showing the overview of a network system according to an example embodiment.

FIG. 2 is a configuration diagram showing a configuration example of a network system according to a first example embodiment.

FIG. 3 is a configuration diagram showing a configuration example of a network device according to the first example embodiment.

FIG. 4 is a flowchart showing an operation example of the network system according to the first example embodiment.

FIG. 5 is an illustrative diagram illustrating an operation example of the network system according to the first example embodiment.

FIG. 6 is an illustrative diagram illustrating an operation example of the network system according to the first example embodiment.

FIG. 7 is a sequence chart illustrating an operation example of the network system according to the first example embodiment.

### DESCRIPTION OF EMBODIMENTS

### Overview of Example Embodiment

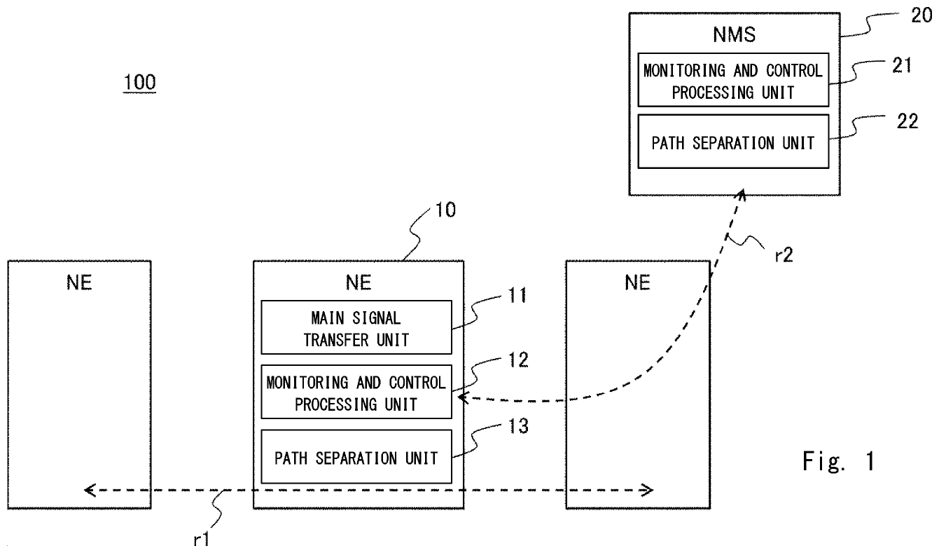

FIG. 1 shows the overview of a network system according to an example embodiment. As shown in FIG. 1, a network system 100 mainly includes a plurality of NEs (Network Elements: network devices) 10 and an NMS (Network Management System: network management device) 20.

A main signal for user data is transferred through a main signal path r1 between the plurality of NEs 10, and a monitoring and control signal for monitoring and controlling the NEs 10 is transmitted and received through a monitoring and control path r2 between the plurality of NEs 10 and the NMS 20.

The NE 10 includes a main signal transfer unit 11, a monitoring and control processing unit 12, and a path separation unit 13. The main signal transfer unit 11 transfers the main signal to the other NEs 10 through the main signal path r1, and the monitoring and control processing unit 12 transmits and receives the monitoring and control signal to and from the NMS 20 through the monitoring and control path r2, and processes the signal. The path separation unit 13 separates the main signal path r1 and the monitoring and control path r2 when unauthorized access to the NE 10 is detected.

The NMS 20 includes a monitoring and control processing unit 21 and a path separation unit 22. The monitoring and control processing unit 21 transmits and receives the monitoring and control signal to and from the NE 10 through the monitoring and control path r2, and processes the signal. The path separation unit 22 separates the main signal path r1 and the monitoring and control path r2 between the NEs 10 when unauthorized access to the NE 10 is detected. Note that the path separation unit may be included in any one of the NE 10 and the NMS 20. Further, an unauthorized access detection unit that detects unauthorized access to the NE 10 may be included in any one of the NE 10 and the NMS 20.

Although security issues are becoming increasingly serious with the sophistication of cyber attacks, a maintenance person often does not recognize intrusion by an attacker. Further, an NE that constitutes a network is demanded not to stop communication services of user data while detecting unauthorized access and taking countermeasures such as eliminating or preventing the proliferation of this unauthorized access.

To achieve this, in this example embodiment, the main signal path for transferring the main signal between the NEs and the monitoring and control path for transmitting and receiving the monitoring and control signal between the NE and the NMS are separated upon detection of unauthorized access to the NE as described above. The separation of the path includes switching a path between the NEs, disconnecting connections inside the NE or the like as described later. This diminishes effects on the main signal while taking countermeasures to unauthorized access.

### First Example Embodiment

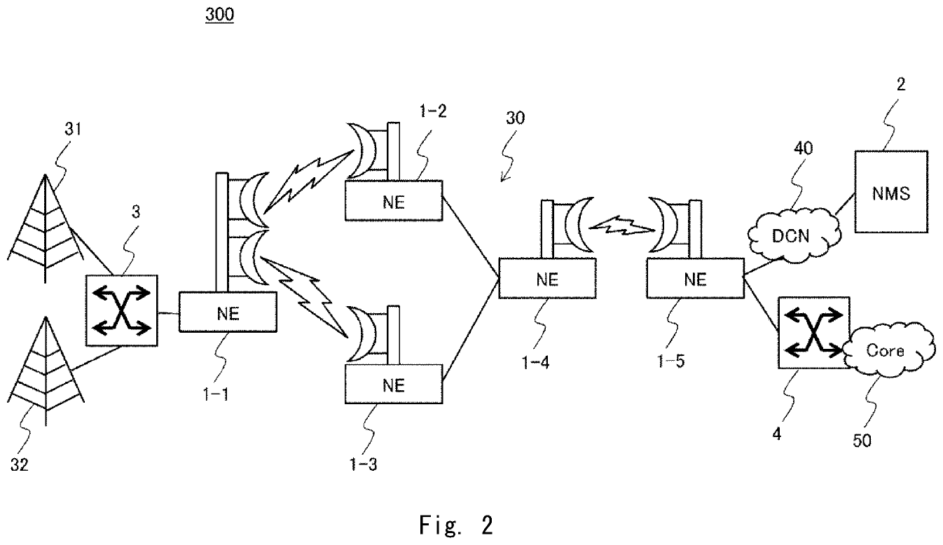

A first example embodiment is described hereinafter with reference to the drawings. FIG. 2 shows a configuration example of a network system 300 according to this example embodiment.

As shown in FIG. 2, the network system 300 according to this example embodiment mainly includes a plurality of NEs (Network Elements) 1-1 to 1-5 (any one of the NEs is referred to also as NE 1) and an NMS (Network Management System) 2.

The NE 1 is a microwave communication device (wireless communication device), for example, and the NEs 1-1 to 1-5 constitute a microwave network (wireless network) 30. The NEs 1-1 to 1-5 are connected by point-to-point connection (opposite connection) between adjacent (opposite) devices, and are connected through a microwave link (wireless link) or a wired communication cable. The NEs 1-1 to 1-5 transfer the main signal (user data) through the microwave link or the wired communication cable.

For example, the NE 1-1 and the NE 1-2, the NE 1-1 and the NE 1-3, and the NE 1-4 and the NE 1-5 are respectively connected through the microwave link to enable wireless communication. The NE 1-2 and the NE 1-4, and NE 1-1 and the NE 1-3 are respectively connected through the wired communication cable to enable wired communication.

Further, the NE 1-1 is connected to base stations 31 and 32 through a router 3. The NE 1-5 is connected to a core network 50 through a router 4. The NE 1-5 is connected to the NMS 2 through a DCN (Data Communications Network) 40.

The NMS 2 is a monitoring and control device (management device) that monitors and controls (manages) the plurality of NEs 1. The NMS 2 transmits and receives a monitoring and control signal (management signal) to and from the plurality of NEs 1 through the DCN 40. Note that the NMS 2 may be connected to an arbitrary NE 1, not limited to the NE 1-5, or may be connected to all the NEs 1 as long as it can transmit and receive the monitoring and control signal to and from the plurality of NEs 1. The NMS 2 is implemented by a computer device such as a server, and it includes functions necessary for operations of this example embodiment, such as the monitoring and control processing unit and the path separation unit in FIG. 1.

The plurality of NEs 1 perform communication (Layer 2 communication) in conformity with the Layer 2 protocol of the OSI (Open Systems Interconnection) reference model through the wireless link. Thus, the plurality of NEs 1 relay (transfer) the user data by Layer 2 communication. For example, a MAC address is allocated to each of the plurality of NEs 1, which construct the Layer 2 network for user data. This network is a data plane network (main signal network) for communicating the user data (main signal), and a path included in this network serves as a user data path (main signal path).

The routers 3 and 4 transmit and receive the user data through the microwave network 30 (data plane) formed by the plurality of NEs 1. The routers 3 and 4 transmit and receive the user data by Layer 3 communication. For example, an IP address is allocated to each of the routers 3 and 4, which construct the Layer 3 network for user data.

The NMS 2 and the plurality of NEs 1 perform communication (Layer 3 communication) in conformity with the Layer 3 protocol. Thus, the NMS 2 transmits and receives the monitoring and control signal by Layer 3 communication to and from the plurality of NEs 1. For example, an IP address is allocated to each of the NMS 2 and the plurality of NEs 1, which construct the Layer 3 network for monitoring and control (management). This network is a management plane network (management network) for communicating the monitoring and control signal (management signal), and a path included in this network serves as a monitoring and control path (management path).

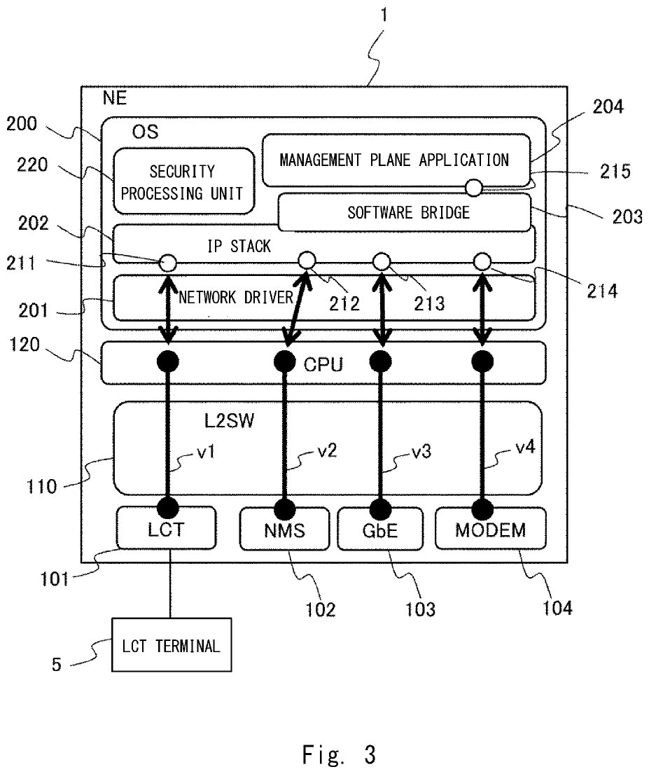

FIG. 3 shows hardware components and software components of the NE 1 according to this example embodiment. As shown in FIG. 3, the NE 1 includes, as hardware components, an LCT port 101, an NMS port 102, a GbE (Gigabit Ethernet) port 103, a MODEM (modem) port 104, a Layer 2 switch (L2SW) 110, and a CPU (Central Processing Unit) 120. It further includes a memory that stores programs and data, an input/output interface and the like.

The NE 1 includes, as software components, a network driver 201, an IP stack 202, a software bridge 203, a management plane application 204, and a security processing unit 220 in an OS (Operating System) 200.

The LCT port (local port) 101 is a physical port for connecting locally to an LCT (Local Craft Terminal) terminal 5 for maintenance work. The LCT port 101 is a local port for local connection and it is not used for transfer of the main signal. For example, when performing maintenance work, a maintenance person connects the LCT port 101 and the LCT terminal 5 directly by a LAN cable (LAN connection) or the like.

The NMS port 102 is a physical port connected for performing monitoring and control communication with the NMS 2 through the DCN 40. The NMS port 102 is a monitoring and control port for remote connection to the monitoring and control path, and it is not used for transfer of the main signal. For example, the NMS port 102 is connected to the DCN 40 or the NMS port 102 of another NE 1 via wired connection through a LAN cable or the like. Further, a plurality of NMS ports 102 may be provided and a plurality of LAN cables may be connected.

The GbE port 103 is a physical port connected for performing user data (main signal) communication via Ethernet (registered trademark). For example, the GbE port 103 is connected to the routers 3 and 4 or the GbE port 103 of another NE 1 via wired connection through a LAN cable or the like. Further, a plurality of GbE ports 103 may be provided and a plurality of LAN cables may be connected.

The MODEM port 104 is a physical port connected for performing wireless communication with another NE 1 via a wireless link. An antenna for microwave communication is connected to the MODEM port 104. Note that a plurality of MODEM ports 104 may be provided and a plurality of antennas may be connected. The GbE port 103 and the MODEM port 104 are main signal ports for connecting to the main signal path.

The LCT port 101, the NMS port 102, the GbE port 103 and the MODEM port 104 serve both as physical ports and Layer 2 interfaces. Specifically, a MAC address is allocated to each of them, and they perform Layer 2 communication by using the MAC address between connected devices.

The Layer 2 switch 110 is connected to the LCT port 101, the NMS port 102, the GbE port 103 and the MODEM port 104, and transfers Layer 2 frames between those ports. The Layer 2 switch 110 is connected also to the CPU 120, and transfers the monitoring and control signal between the CPU 120 and those ports. The Layer 2 switch 110 is a switch circuit that switches the main signal of the main signal path and the monitoring and control signal of the monitoring and control path, and it serves as a main signal transfer unit. Note that a Layer 3 switch or another switch may be used, not limited to the Layer 2 switch.

The Layer 2 switch 110 stores an address table (not shown), and transfers the Layer 2 frame in accordance with the settings in the address table. For example, in the address table, entries where a VLANID, a MAC address and a port number (physical port or CPU) are associated with one another are set. The entries in the address table may be set by the CPU (control unit) 120, or may be automatically set in accordance with protocols such as an STP (Spanning Tree Protocol) and an ERP (Ethernet Ring Protection).

In this example, a VLAN (Virtual Local Area Network) for connecting each port and the CPU 120 is set. The VLAN is an example of virtual network connection, and connection may be made by another virtual connection. A VLAN v1 for LCT is set between the LCT port 101 and the CPU 120, a VLAN v2 for NMS is set between the NMS port 102 and the CPU 120, a VLAN v3 for in-band management is set between the GbE port 103 and the CPU 120, and a VLAN v4 for MODEM is set between the MODEM port 104 and the CPU 120. Note that the main signal path is set between the GbE port 103 and the MODEM port 104, and user data is transferred through it.

The network driver 201 transfers the monitoring and control signal between the Layer 2 switch 110 (CPU 120) and the IP stack 202. The network driver 201 transfers the frame of the VLAN v1 for LCT to an IF 211 for LCT of the IP stack 202, transfers the frame of the VLAN v2 for NMS to an IF 212 for NMS of the IP stack 202, transfers the frame of the VLAN v3 for in-band management to an IF 213 for in-band of the IP stack 202, and transfers the frame of the VLAN v4 for MODEM to an IF 214 for MODEM of the IP stack 202. The monitoring and control signal is transferred between the CPU 120 and each port through the Layer 2 switch 110, and further the monitoring and control signal is transferred between the Layer 2 switch 110 and the IP stack 202 through the network driver 201, and thereby the CPU 120 (including the blocks in the OS 200) implements monitoring and control communication.

The IP stack 202 is an IP processing unit that processes frames in accordance with IP (Internet Protocol) protocols, and it includes the software bridge 203. In the IP stack 202, the IF 211 for LCT is set for performing IP processing for LCT (for local). For example, the IF 211 for LCT is the Layer 3 interface, and an IP address for LCT is set. The IF 211 for LCT and the LCT port 101 are virtually connected by the VLAN v1, and the IP stack 202 performs Layer 3 communication with the LCT terminal 5. The IP stack 202 may perform address translation such as NAPT (Network Address Port Translation) according to need. For example, address translation is carried out to access another NE 1 (IP address of the DCN network) via the DCN 40 by using the software bridge 203 (IP address of the DCN network) from the LCT port 101 (IP address of the local network).

Further, in the IP stack 202, the IF 212 for NMS, the IF 213 for in-band, the IF 214 for MODEM, and an IF 215 for bridge are set for performing IP processing for NMS, GbE and MODEM. For example, the IF 212 for NMS, the IF 213 for in-band and the IF 214 for MODEM are the Layer 2 interfaces, and MAC addresses (or VLANs) for NMS, GbE and MODEM are set. The IF 215 for bridge is the Layer 3 interface, and an IP address for management (monitoring and control) is set. The software bridge 203 transfers a frame between the IF 212 for NMS and the IF 215 for bridge, transfers a frame between the IF 213 for in-band and the IF 215 for bridge, and transfers a frame between the IF 214 for MODEM and the IF 215 for bridge.

The management plane application 204 is a management application (monitoring and control processing unit), and it transmits and receives the monitoring and control signal to and from the NMS 2. The management plane application 204 controls (sets) each port, the Layer 2 switch 110 and the like in accordance with the monitoring and control signal from the NMS 2. They can be controlled in the same manner also by the locally connected LCT terminal 5.

The IF 212 for NMS and the NMS port 102 are virtually connected by the VLAN v2, the IF 214 for MODEM and the MODEM port 104 are virtually connected by the VLAN v4, and the IF 213 for in-band and the GbE port 103 are virtually connected by the VLAN v3. Further, the management plane application 204 performs Layer 3 communication from the IF 215 for bridge through the VLANs v2 to v4 and each port. The path through the IF 215 for bridge, the IF 212 for NMS, the VLAN v2, and the NMS port 102 is the monitoring and control path for transmitting and receiving the monitoring and control signal.

The security processing unit 220 performs attack detection, port shutdown and the like as processing necessary for security countermeasures. The security processing unit 220 includes an unauthorized access detection unit, a port shutdown unit (path separation unit) and the like. To shut down a physical port, the status of each port is switched from Enable to Disable. To disconnect a connection between the CPU 120 and each port, the status of a VLAN between the CPU 120 and each port is switched from Enable to Disable.

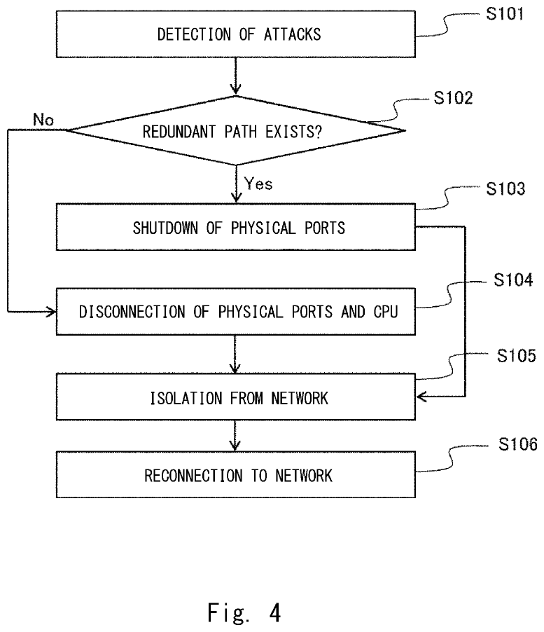

The flowchart of FIG. 4 shows an operation example of a network system according to this example embodiment.

As shown in FIG. 4, the presence or absence of attacks is monitored in the network system to detect attacks (S101). For example, attacks to the NE 1 are detected by unauthorized event detection by log monitoring, CPU and memory usage rate monitoring, anomaly detection by virus and malware scanning, unauthorized access and unauthorized communication detection by connect session number monitoring and the like. Any one of those indices may be used, or a plurality of arbitrary indices may be used for detection. It is possible to detect attacks accurately by determining that attacks are detected when those plurality of indices are significantly higher than normal average values. Note that attacks may be detected by another arbitrary method.

The attack detection may be conducted by any one of the NE 1 and the NMS 20. Specifically, attack detection may be carried out in the security processing unit 220 of the NE 1 and a detection result may be notified to the NMS 20, or the NMS 20 may monitor the NE 1 and detect the NE 1 being attacked.

Next, processing depending on the presence or absence of a redundant path is performed as a response to the detected attacks (S102 to S105). In this step, it is determined whether there is a redundant path for the path including the NE 1 where attacks are detected (S102). The presence or absence of a redundant path may be determined in any one of the NE 1 and the NMS 20. For example, in the NE 1, the Layer 2 switch 110 can determine whether there is a redundant path by using the STP, the ERP or the like. The NMS 20 can also determine whether there is a redundant path because it manages the paths of the plurality of NEs 1.

When it is determined that there is a redundant path, the physical ports of the NE 1 are shut down (S103), and the NE 1 is isolated from the network (S105). In this case, the main signal path is switched to the redundant path after isolating the NE 1.

The NE 1 shuts down the NMS port 102, the GbE port 103 and the MODEM port 104, which are physical ports. The LCT port 101 is not shut down and remains in the state of allowing local connection only. Local connection of the LCT terminal 5 enables recovery work.

Switching to the redundant path may be performed in any one of the NE 1 and the NMS 20. For example, in the NE 1, the Layer 2 switch 110 can switch the path by using the STP, the ERP or the like. The NMS 20 can also switch the path to the redundant path because it manages the paths of the plurality of NEs 1.

On the other hand, when it is determined that there is no redundant path, connections between the physical ports and the CPU in the NE 1 are disconnected (S104), and thereby the CPU 120 of the NE 1 is isolated from the network (S105). The NE 1 disconnects the VLAN connections (connections including the monitoring and control path) between the NMS port 102, the GbE port 103 and the MODEM port 104, which are physical ports, and the CPU 120. The physical ports are not shut down. Because the main signal path is not disconnected, transfer through the main signal path is possible. Further, the LCT port 101 does not disconnect a connection with the CPU to allow local connection. Local connection of the LCT terminal 5 enables recovery work. Note that, because there is a possibility that a means of intrusion through the Layer 2 switch is found by an attacker even if the CPU connection is disconnected, it is preferable to switch to a redundant path when there is the redundant path for the main signal.

By isolating (separating) the NE 1 or the CPU 120 of the NE 1 from the network, it is possible to block an intrusion route of an attacker. In this example embodiment, to separate the main signal path and the monitoring and control path in the NE 1, when there is a redundant path, the NE 1 is isolated from the network by switching to the redundant path and shutdown of the physical ports, and when there is no redundant path, the CPU 120 of the NE 1 is isolated from the network by disconnecting the CPU connection including the monitoring and control path. Note that an unauthorized account of the NE 1 where attacks are detected may be locked out so that login cannot be made with the unauthorized account.

After that, as recovery processing, the NE 1 is reconnected to the network once safety is confirmed (S106). When a maintenance person determines that it is safe, reconnection to the network (the other NEs 1 and the NMS 2) is made by locally connecting the LCT terminal 5 to the LCT port 101 to thereby release the physical ports or connect the physical ports to the CPU. The maintenance person makes a reconnection after changing the alarm status of the NE 1 from an attack detection state (Alarm) to a normal state (Cleared). On the other hand, when a maintenance person determines that it is dangerous, the reconnection is made after initialization and reconfiguration of the NE 1. For example, reconnection to the network is made after backup of the configuration information of the NE 1, reinstallation and reconfiguration.

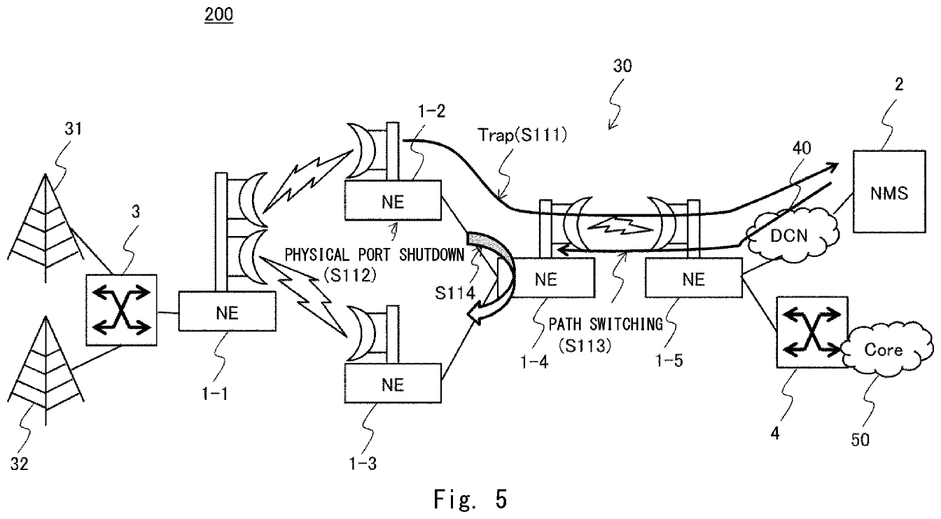

FIG. 5 shows an operation example in the case where there is a redundant path. In the example of FIG. 5, when the NE 1-2 detects attacks, the NE 1-2 notifies the NMS 2 of detection of attacks (S111). The NE 1-2 sends, to the NMS 2, “SNMP Trap” message where Attack Detection Alarm is set. The NMS 2 receives a notification of attack detection and displays Alarm or the like according to need. Then, because the redundant path exists, the NE 1-2 shuts down the physical ports (the NMS port 102, the GbE port 103 and the MODEM port 104) other than the LCT port 101 and thereby isolates the NE 1-2 from the network (S112).

After that, the NMS 2 makes settings to switch the path for the NE 1-4 (S113), and the NE 1-4 receives the settings for path switching from the NMS 2 and carries out switching of the path (S114). The NMS 2 sends, to the NE 1-4, “SNMP Set” message where switching from the path through the NE 1-2 to the path through the NE 1-3 is set. The NE 1-4 receives the “SNMP Set” and switches the path to the path through the NE 1-3. Note that, as described above, path switching may be made autonomously between the NEs 1 by using the STP/ERP or the like rather than control from the NMS 2. By switching the path in this manner, it is possible to relay the user data (main signal) through the NE 1-3.

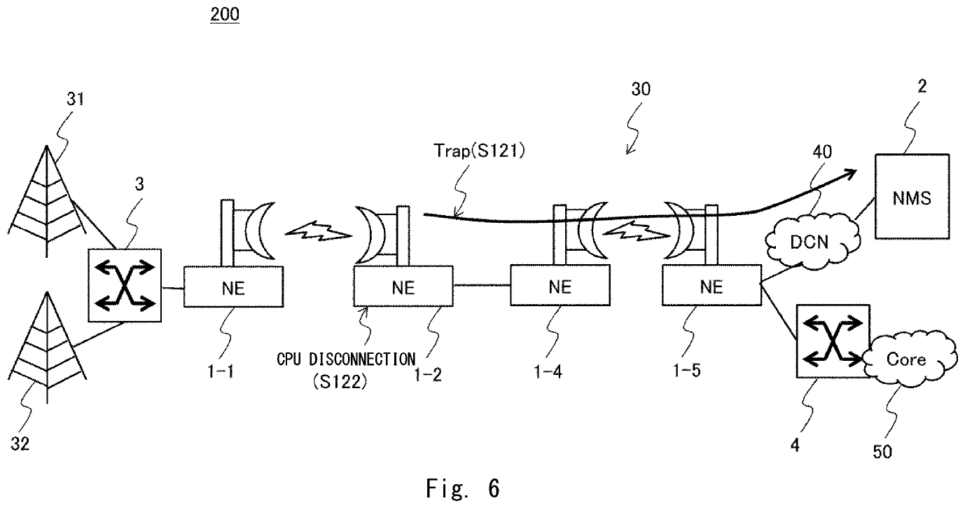

FIG. 6 shows an operation example in the case where there is no redundant path. In the example of FIG. 6, when the NE 1-2 detects attacks, the NE 1-2 notifies the NMS 2 of detection of attacks in the same manner as in FIG. 5 (S121). Then, because the redundant path does not exist, the NE 1-2 disconnects the connections between the physical ports (the NMS port 102, the GbE port 103 and the MODEM port 104) other than the LCT port 101 and the CPU 120, and thereby isolates the CPU 120 of the NE 1-2 from the network (S122). By disconnecting only the CPU connection in the NE 1-2, it is possible to relay the user data (main signal) through the Layer 2 switch 110 of the NE 1-2.

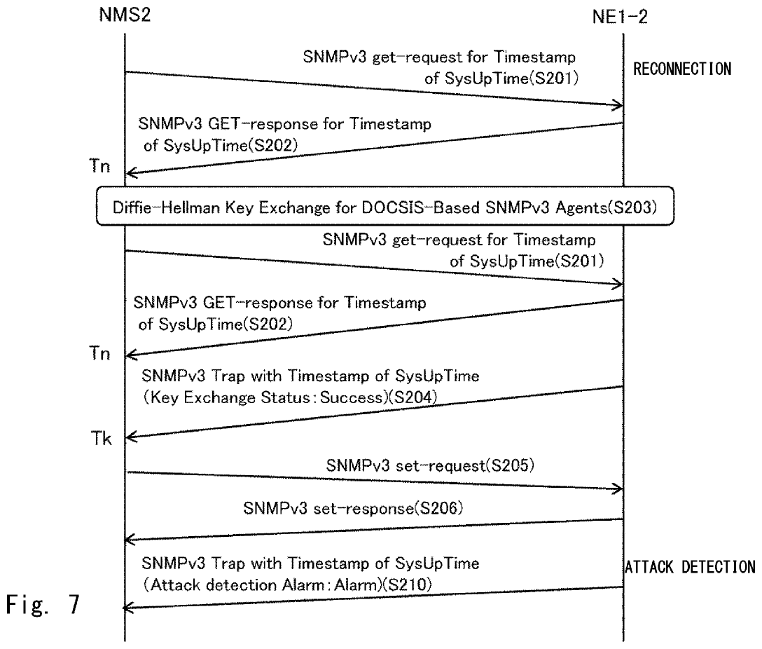

FIG. 7 shows an operation example for reconnection of the NE 1. In this example embodiment, reconnection to the network is made by performing mutual authentication between the NMS 2 and the NE 1 once safety is confirmed by a maintenance person.

After the NE 1-2 is reconnected, the NMS 2 sets the alarm status of the NE 1-2 to the normal state (Cleared) and performs alive monitoring (S102, S202) and mutual authentication (S203, S204) of the NE 1-2.

For alive monitoring of the NE 1-2, the NMS 2 sends “SNMPv3 get-request for Timestamp of SysUpTime” message to the NE 1-2 at regular intervals by using a user name registered in the NE 1-2 (S201), and the NE 1-2 sends “SNMPv3 get-response for Timestamp of SysUpTime” message to the NMS 2 (S202). It is assumed in this example that SysUpTime is not in time synchronization or cannot establish time synchronization. The NMS 2 determines that the NE 1-2 is normal when it receives the “SNMPv3 get-response for Timestamp of SysUpTime” within a predetermined period of time.

Further, for mutual authentication between the NMS 2 and the NE 1-2, Diffie-Hellman key exchange (Diffie-Hellman Key Exchange for DOCSIS-Based SNMPv3 Agents) processing is performed (S203). For example, key exchange from the NMS 2 to the NE 1-2 is carried out by “SNMPv3 get-request” (S205) and “SNMPv3 get-response” (S206), and key exchange from the NE 1-2 to the NMS 2 is carried out by “SNMPv3 Trap with Timestamp of SysUpTime (Key Exchange Status: Success)” (S204). The NMS 2 and the NE 1-2 determine that authentication is successful when the received keys can be decrypted at both ends. Although Diffie-Hellman Key Exchange is performed as a means of mutual authentication in this example, another method may be used.

Multi-check (multi-layer check) is done by the alive monitoring and the mutual authentication. The NMS 2 checks the validity by comparing the latest get-response and SysUpTime of Key Exchange Trap. With get-response (SysUpTime)=Tn and Key Exchange Trap (SysUpTime)=Tk, the validity is checked based on whether the relationship of (regular interval of alive monitoring)>Tk−Tn is satisfied or not, for example. This enhances the safety by multi-layer check even for the UDP-based SNMP with less reliability.

Detection of attacks may be performed in any one or both of the NE 1 and the NMS 20 as described above. For example, when the NMS 20 determines that there is anomaly in the validity check, it changes the alarm status of the NE 1-2 to an attack detection state (Attack detection Alarm: Alarm) in order to prohibit reconnection of the NE 1-2. The NE 1-2 sends, to the NMS 2, “SNMPv3 Trap with Timestamp of SysUpTime (Attack detection Alarm: Alarm)” which is used for notification to the NMS 2 upon attack detection (S210), and performs processing depending on the redundant path as described above. At this time, the alarm status of the NE 1-2 is the attack detection state (Alarm).

As described above, in this example embodiment, upon detection of unauthorized access in an NE that constitutes a network, a path is switched to isolate the NE from the network when there is a redundant path, or CPU connection in the NE is disconnected to isolate the CPU of the NE from the network when there is no redundant path. Therefore, when unauthorized access is detected, it is possible to separate this device or functions other than the minimum necessary communication functions of this device from the network while maintaining user data communication without stopping communication of the user data. It is thereby possible to isolate the NE being attacked from the network and block intrusion into a network by an attacker without stopping communication services the main signal.

Further, once safety is confirmed by a maintenance person after the NE that has detected attacks autonomously leaves the network, the NMS and the NE perform mutual authentication and reconnect to the network. It is thereby possible to restart the services securely through this NE.

It should be noted that the present invention is not limited to the above-described embodiments and may be varied in many ways within the scope of the present invention.

Each element in the above-described example embodiment may be formed by hardware or software or both of them, and may be formed by one hardware or software or a plurality of hardware or software. The function (processing) of each device may be implemented by a computer including a CPU, a memory and the like. For example, a control program for performing a control method according to the example embodiment may be stored in a storage device, and each function may be implemented by executing the control program stored in the storage device on the CPU.

The program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

This application is based upon and claims the benefit of priority from Japanese patent application No. 2017-047574 filed on Mar. 3, 2017, the disclosure of which is incorporated herein in its entirety by reference.

### REFERENCE SIGNS LIST

1, 10 NE
2, 20 NMS
3, 4 ROUTER
5 LCT TERMINAL
11 MAIN SIGNAL TRANSFER UNIT
12 MONITORING AND CONTROL PROCESSING UNIT
13 PATH SEPARATION UNIT
21 MONITORING AND CONTROL PROCESSING UNIT
22 PATH SEPARATION UNIT
30 MICROWAVE NETWORK
31, 32 BASE STATION
50 CORE NETWORK
100 NETWORK SYSTEM
101 LCT PORT
102 NMS PORT
103 GbE PORT
104 MODEM PORT
110 LAYER 2 SWITCH
120 CPU
200 OS
201 NETWORK DRIVER
202 IP STACK
203 SOFTWARE BRIDGE
204 MANAGEMENT-PLANE APPLICATION
211 LCT IF
212 NMS IF
213 IN-BAND IF
214 MODEM IF
215 BRIDGE IF
220 SECURITY PROCESSING UNIT
300 NETWORK SYSTEM

1. A network device comprising:
a memory storing instructions, and
a processor configured to execute the instructions stored in the memory to;
transfer a main signal for user data through a main signal path between the network device and another network device;
transmit and receive a monitoring and control signal for monitoring and control through a monitoring and control path between the network device and a monitoring and control device; and
separate the main signal path and the monitoring and control path upon detection of unauthorized access.

2. The network device according to claim 1, wherein, when there is a redundant path for the main signal path, the processor is further configured to execute the instructions stored in the memory to switch the main signal path containing the network device where the unauthorized access is detected to the redundant path.

3. The network device according to claim 2, wherein the processor is further configured to execute the instructions stored in the memory to switch the main signal path to the redundant path in response to control from the monitoring and control device.

4. The network device according to claim 2, wherein the processor is further configured to execute the instructions stored in the memory to switch the main signal path to the redundant path in accordance with a path control protocol for controlling the main signal path between the network device and the another network device.

5. The network device according to claim 1, comprising:
a main signal port configured to connect to the main signal path; and
a monitoring and control port configured to connect to the monitoring and control path,
wherein, when there is a redundant path for the main signal path, the processor is further configured to execute the instructions stored in the memory to shut down the main signal port and the monitoring and control port.

6. The network device according to claim 5, wherein the main signal port includes a wireless communication port for connecting a wireless communication antenna or a wired communication port for connecting a wired communication cable.

7. The network device according to claim 5, comprising:
a local port configured to locally connect a terminal device,
wherein, when there is a redundant path for the main signal path, the processor is further configured to execute the instructions stored in the memory to shut down the main signal port and the monitoring and control port without shutting down the local port.

8. The network device according to claim 1, comprising:
a switch circuit configured to switch the main signal of the main signal path and the monitoring and control signal of the monitoring and control path,
wherein, when there is no redundant path for the main signal path, the processor is further configured to execute the instructions stored in the memory to disconnect the monitoring and control path without disconnecting the main signal path in the switch circuit.

9. The network device according to claim 8, wherein
the main signal path and the monitoring and control path are connected via virtual network connection in the switch circuit, and
the processor is further configured to execute the instructions stored in the memory to disconnect a virtual network connection of the monitoring and control path without disconnecting a virtual network connection of the main signal path.

10. The network device according to claim 8, comprising:
a main signal port configured to connect to the main signal path; and
a monitoring and control port configured to connect to the monitoring and control path,
wherein the processor is further configured to execute the instructions stored in the memory to disconnect the monitoring and control path through the monitoring and control port without disconnecting the main signal path through the main signal port.

11. The network device according to claim 10, comprising:
a local port configured to locally connect a terminal device,
wherein the processor is further configured to execute the instructions stored in the memory to disconnect the monitoring and control path through the monitoring and control port without disconnecting a connection through the local port and the main signal path through the main signal port.

12. The network device according to claim 1,
wherein the processor is further configured to execute the instructions stored in the memory to reconnect to a network containing the monitoring and control path after separating the main signal path and the monitoring and control path.

13. The network device according to claim 12, wherein the processor is further configured to execute the instructions stored in the memory to perform mutual authentication with the monitoring and control device when making the reconnection.

14. A monitoring and control device for monitoring and controlling a network device constituting a network, comprising:
a memory storing instructions, and
a processor configured to execute the instructions stored in the memory to;
transmit and receive a monitoring and control signal for monitoring and control through a monitoring and control path between the monitoring and control device and the network device; and
separate a main signal path for transferring a main signal for user data by the network device and the monitoring and control path upon detection of unauthorized access to the network device.

15. (canceled)

16. A method of controlling a network device constituting a network, comprising:
transferring a main signal for user data through a main signal path between the network device and another network device;
transmitting and receiving a monitoring and control signal for monitoring and control through a monitoring and control path between the network device and a monitoring and control device; and
separating the main signal path and the monitoring and control path upon detection of unauthorized access.

17. A method of controlling a monitoring and control device for monitoring and controlling a network device constituting a network, comprising:
transmitting and receiving a monitoring and control signal for monitoring and control through a monitoring and control path between the monitoring and control device and the network device; and
separating a main signal path for transferring a main signal for user data by the network device and the monitoring and control path upon detection of unauthorized access to the network device.

18. (canceled)
